(19) United States
(12) Patent Application Publication
(10) Pub. No.: US 2011/0267165 A1
(43) Pub. Date: Nov. 3, 2011

(54) INDUCTOR ASSEMBLY FOR A MAGNETIC RESONANCE IMAGING SYSTEM

(76) Inventors: Victor Taracila, Orange Village, OH (US); Fraser Robb, Aurora, OH (US); Aleksey Zemskov, Solon, OH (US); Vijayanand Alagappan, Streetsboro, OH (US); Miguel Navarro, Sheffield Village, OH (US); Robert Minnich, Cortland, OH (US)

(21) Appl. No.: 12/772,720

(22) Filed: May 3, 2010

(51) Int. Cl. H01F 5/00; H01F 41/04

(52) U.S. Cl. 336/200; 29/605

(57) ABSTRACT

An inductor assembly includes a substrate having a first surface and an opposing second surface, a first spiral electrical conductor formed on the first surface, a second spiral electrical conductor formed on the second surface, at least one opening extending through the first and second surfaces, and a metallic pin configured to be inserted in the opening, the pin coupling the first conductor to the second conductor. An RF coil including the inductor assembly and a method of fabricating an inductor assembly are also described.

### BACKGROUND OF THE INVENTION

The subject matter disclosed herein relates generally to radio frequency (RF) coils, and more particularly to an inductor used in an RF coil.

Magnetic Resonance Imaging (MRI) systems include a magnet, such as a superconducting magnet that generates a temporally constant (i.e., uniform and static) primary or main magnetic field. MRI data acquisition is accomplished by exciting magnetic moments within the primary magnetic field using magnetic gradient coils. For example, in order to image a region of interest, the magnetic gradient coils are energized to impose a magnetic gradient to the primary magnetic field. Transmit radio-frequency (RF) coils are then pulsed to create RF magnetic field pulses in a bore of an MRI scanner to selectively excite a volume corresponding to the region of interest in order to acquire MR images of the region of interest using receive RF coils. During the transmission of the RF magnetic field pulses, the receive RF coils are decoupled. The resultant image that is generated shows the structure and function of the region of interest.

Conventional RF coils include an inductor that is typically resonated with a capacitor by creating a parallel resonant tank circuit. During operation, as the inductive reactance increases with increasing frequency and the capacitive reactance decreases with increasing frequency, there is only one frequency at which the reactance of the inductor and the reactance of the capacitor are in resonance. In general, when the reactance of the capacitor is substantially equal to the reactance of the inductor the tank circuit is in resonance.

One of the requirements for tuning the tank circuit is to be able to modify the inductor's geometry in order to tune the inductor to have substantially the same resonant frequency as the MRI system. Stretching or compressing the conventional inductor usually achieves the desired inductance, so that the magnetic flux density inside the inductor decreases or increases, respectively. After the inductor has been formed into a final state, the inductor is coated with a substance to maintain the inductor in the final state.

However, in some applications, such as MRI systems, there is a need to minimize the size of the lump circuit components including the inductor. However, when the conventional inductor is utilized in certain operational environments, for example, in a MRI system, the geometry of the inductors may cause the installer to compress or otherwise alter the inductor to enable the inductor to be secured in the system. Altering or otherwise modifying the shape of the conventional inductor may also cause the inductance of the inductor to change.

### BRIEF DESCRIPTION OF THE INVENTION

In accordance with one embodiment, an inductor assembly is provided. The inductor assembly includes a substrate having a first surface and an opposing second surface, a first spiral electrical conductor formed on the first surface, a second spiral electrical conductor formed on the second surface, at least one opening extending through the first and second surfaces, and a metallic pin configured to be inserted in the opening, the pin coupling the first conductor to the second conductor.

In accordance with another embodiment, an RF coil including a capacitor and an inductor assembly is provided. The inductor assembly includes a substrate having a first surface and an opposing second surface, a first spiral electrical conductor formed on the first surface, a second spiral electrical conductor formed on the second surface, at least one opening extending through the first and second surfaces, and a metallic pin configured to be inserted in the opening, the pin coupling the first conductor to the second conductor.

In accordance with a further embodiment, a method of fabricating an inductor assembly is provided. The method includes forming a first spiral electrical conductor on a first surface of a dielectric substrate, forming a second spiral electrical conductor on a opposite second surface of the dielectric substrate, forming at least one opening through the dielectric substrate and the first and second conductors, inserting a metallic pin into the at least one opening such that the first conductor is electrically coupled to the second conductor via the pin to form an inductor, and coupling the inductor assembly in parallel with a capacitor.

### BRIEF DESCRIPTION OF THE DRAWINGS

FIG. 1 is a simplified schematic illustration of an exemplary tank circuit formed in accordance various embodiments.

FIG. 2 is a top view of an exemplary inductor assembly formed in accordance with various embodiments.

FIG. 3 is a top perspective view of the exemplary inductor assembly shown in FIG. 2.

FIG. 4 is a side view of the exemplary inductor assembly shown in FIG. 2.

FIG. 5 is a top view of another exemplary inductor assembly formed in accordance with various embodiments.

FIG. 6 is a top view of another exemplary inductor assembly formed in accordance with various embodiments.

FIG. 7 is a graphical illustration of an exemplary function that may be utilized to determine the locations of the openings in inductor assemblies described herein.

FIG. 8 is a flowchart of an exemplary method of fabricating an inductor assembly in accordance various embodiments.

FIG. 9 is a pictorial view of an exemplary medical imaging system that may be utilized with an exemplary inductor assembly formed in accordance with various embodiments.

FIG. 10 is a simplified schematic illustration of the medical imaging system shown in FIG. 9.

### DETAILED DESCRIPTION OF THE INVENTION

The foregoing summary, as well as the following detailed description of certain embodiments, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments described herein provide an inductor assembly that may be utilized to form a resonant circuit with a capacitor utilized in an a radio-frequency (RF) coil. By practicing at least one embodiment, the inductor assemblies described herein may be tuned prior to being installed in the MRI system, thus reducing labor costs associated with installation and tuning. The various inductor assemblies may be implemented in connection with different types of magnetic resonance coils, for example surface coils, operating at different frequencies, thus having different wavelengths.

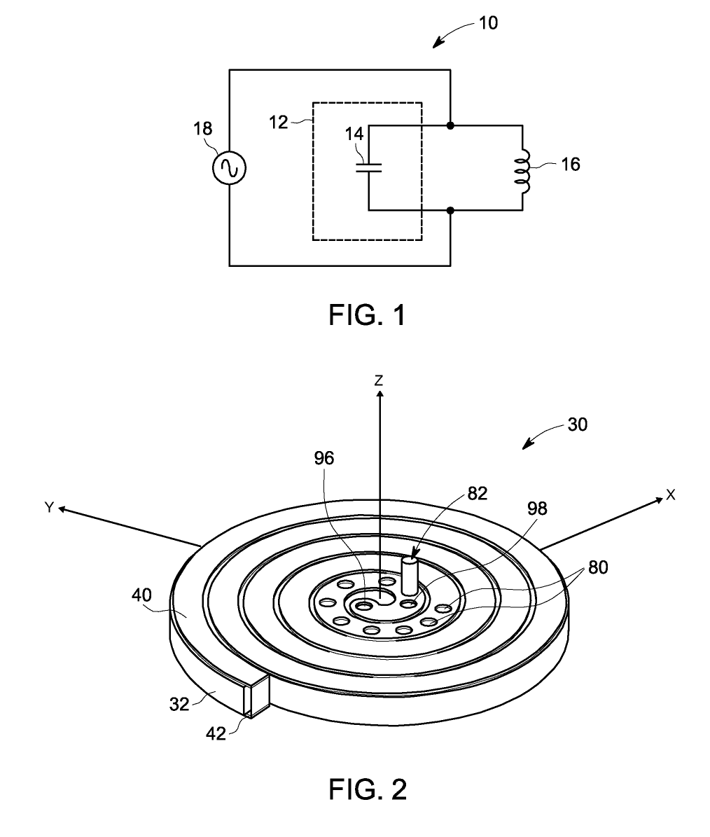

FIG. 1 is schematic illustration of an exemplary tank circuit 10 that forms a portion of an exemplary RF coil 12. A tank circuit, as used herein, is a resonant or tuned circuit that includes a capacitor 14 that is coupled in parallel with an inductor 16. The tank circuit 10 may also be referred to herein as a parallel resonant tank. During operation, when an electric current 18, represented by the source 18, is transmitted through the tank circuit 10, the electric current can alternate between the capacitor 14 and the inductor 16 at the tank circuits resonant frequency f. During operation, when the reactance of the capacitor 14 is substantially equal to the reactance of the inductor 16, the tank circuit 10 is in resonance. Thus, the values of the capacitor 14 and the inductor 16 are selected based on the desired system resonant frequency f.

More specifically, because inductive reactance increases with an increasing system frequency f, and capacitive reactance decreases with an increase in the system frequency f, there is a frequency wherein the capacitive reactance is substantially equal to the inductive reactance. In the exemplary embodiment, the inductive reactance X_{L} of the inductor 16 may be determined in accordance with:

X_{L}=2πf₀L;

where f is the system frequency; and

L is the inductance value of the inductor 16.

The capacitive reactance X_{C} of the capacitor 14 may be determined in accordance with:

$$\begin{matrix}{X}_{C} = \frac{1}{2 π fC} & Equation 1 \\ 2 π fL = \frac{1}{2 π fC} & Equation 2\end{matrix}$$

where f is the system frequency; and

C is the capacitance value of the capacitor 14.

In the exemplary embodiment, if the tank circuit 10 forms a portion of the RF coil 12, then the system frequency is predetermined based on the operational frequency of the system to which the RF coil 12 is utilized. For example, in one embodiment, the RF coil is configured to be utilized with an MRI imaging system. Therefore, the resonant frequency of the tank circuit is determined based on the system frequency f of the MRI imaging system. Because capacitors, such as the capacitor 14 for example, form a portion of the RF coil and are utilized to tune the RF coil, the capacitance value of the capacitor 14 is typically predetermined and remains unchanged. Therefore, because the system frequency f and the value of the capacitor 14 is generally known and fixed, an inductor, such as inductor 16, having an inductance value that enables the tank circuit 10 to resonate at the system frequency f is coupled in parallel with the capacitor 14.

More specifically, if the system frequency f is known, and the capacitance value of the capacitor selected to be used with the inductor assembly is known, the value of the inductor may be determined in accordance with:

$$L = \frac{1}{{( 2 π f )}^{2} C} \qquad Equation 3$$

For example, assuming that the system resonant frequency f is determined to be 128 MegaHertz (MHz). Moreover, assuming for example that the capacitance value of the capacitor 14 selected to be used with the system is 10 picoFarads (pF), then the inductance of the inductor 16 is determined in accordance with:

$$L = \frac{1}{{( 2 π * 128 * {10}^{6} )}^{2} * ( 10 * {10}^{- 12} )} \qquad Equation 4$$

However, as discussed above, it is often difficult to utilize a conventional inductor because during installation, the conventional inductor may be compressed or otherwise altered such that the reactance of the conventional inductor changes and the tank circuit 10 is no longer in resonance.

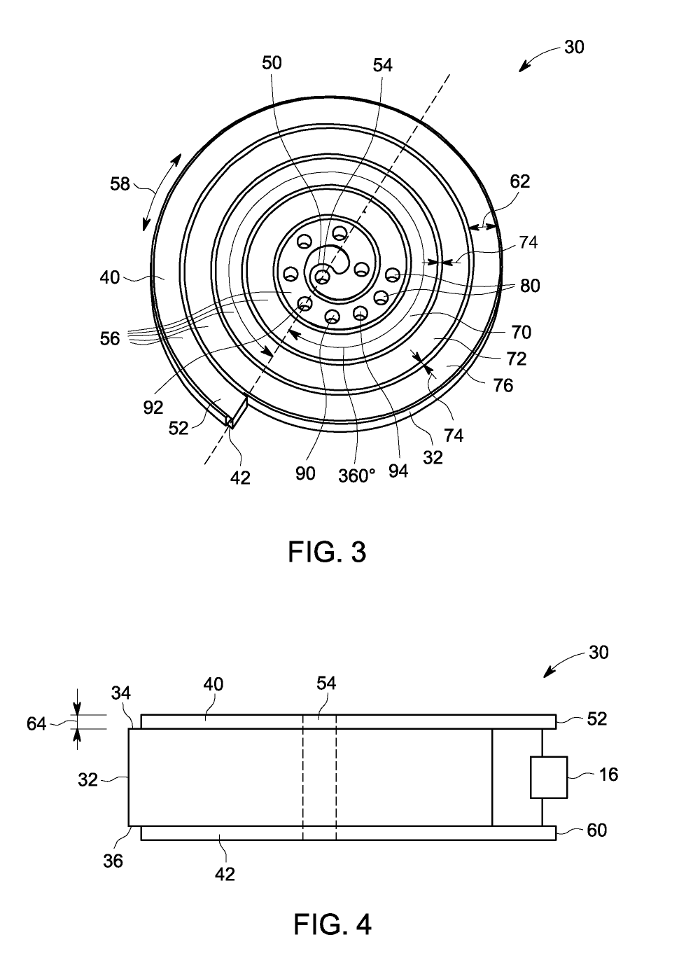

FIG. 2 is a top view of an exemplary rigid tunable spiral inductor assembly 30 that may be used with the tank circuit 10 shown in FIG. 1 in accordance with various embodiments. FIG. 3 is a top perspective view of the exemplary inductor assembly 30 shown in FIG. 2. FIG. 4 is a side view of the exemplary inductor assembly 30 shown in FIG. 2.

In the exemplary embodiment, the inductor assembly 30 includes a substrate 32 having a first surface 34 and an opposing second surface 36. The substrate 32 is fabricated using a dielectric material such as, for example FR4. FR4 is dielectric material that may be, for example, a fiberglass reinforced epoxy laminate that is flame retardant (FR) and self-extinguishing.

The inductor assembly 30 also includes a first spiral electrical conductor 40 that is formed on the first surface 34 of the substrate 32 and a second spiral electrical conductor 42 that is formed on the second surface 36 of the substrate 32. The first and second spiral conductors 40 and 42 are each rigidly coupled to the substrate 32. In the exemplary embodiment, the first spiral conductor 40 is symmetrical with the second spiral conductor 42. More specifically, the first spiral conductor 40 has substantially the same size, shape, and relative orientation as the second spiral conductor 42, but is disposed on an opposite side of the substrate 32. Therefore, although the first spiral conductor 40 is described in detail below, it should be realized that the second spiral conductor 42 is formed and has substantially the same dimensions and operational characteristics as the first spiral conductor 40.

As shown in FIG. 3, the first spiral conductor 40 has a first end 50 and an opposite second end 52. The first end 50 is disposed proximate to a center point 54. The second end 52 is disposed radially outward from the center point 54 proximate to an edge of the substrate 32. The spiral conductors 40 and 42 each form a plane curve traced by a point circling about the center point 54 but at ever-increasing distances from center point 54. Therefore, the spiral conductor 40 includes a plurality of turns 56 that are coplanar with respect to each other. In the exemplary embodiment, the spiral conductor 40 includes five turns 56 wherein each turn 56 spans approximately 360 degrees and has an overall length 58 of approximately 1800 degrees. As shown in FIG. 4, during assembly, the first spiral conductor second end 52 and the second spiral conductor second end 60 are each coupled to a capacitor, such as the capacitor 14 shown in FIG. 1.

Referring again to FIGS. 3 and 4, the plurality of turns 56 each have a width 62 and a thickness 64. In the exemplary embodiment, the width 62 is larger than the thickness 64 such that the spiral conductors 40 and 42 have a substantially rectangular cross-sectional profile. Additionally, each of the turns 56 is separated from the other turns 56 by a predetermined distance. For example, a turn 70 is separated from a turn 72 by a gap 74. Moreover, the turn 72 is separated from a turn 76 by the gap 74. The predetermined size of the gap 74 facilitates electrically isolating the turns 56 from each other. As discussed above, the first and second spiral conductors 40 and 42 each have a width 62 and a thickness 64 that is smaller than the width 62. In the exemplary embodiment, the mathematical shape of the inductor assembly 30 represents an Archimedes spiral which is defined as:

R_{central}(φ)=R₀+s(φ−φ₀) Equation 5

where:

w is the width of the spiral conductor;

w_{gap} is the width of the gap between the turns;

R₀ is the starting radius of the turns;

φ₀=π−the starting angle having a slope

$$s = \frac{w + {w}_{gap}}{2 π} ;$$

The Cartesian coordinates for the spiral conductors 40 and 42 may be defined as:

x_{central}(φ)=R_{central}(φ)cos(φ),

y_{central}(φ)=R_{central}(φ)sin(φ).

Referring again to FIG. 2, the inductor assembly 30 further includes at least one opening 80 that extends through the first conductor 40, the substrate 32, and the second spiral conductor 42. In the exemplary embodiment, the inductor assembly 30 includes a plurality of openings 80 that each extend through the first conductor 40, the substrate 32, and the second spiral conductor 42 extending between the first and second surfaces. The inductor assembly 30 further includes a pin 82 that is configured to be inserted into at least one of the openings 80. In the exemplary embodiment, the pin 82 is configured to be inserted into only one of the openings to form an operational inductor as is discussed in more detail below. The pin 82 is fabricated from a conductive material, such as copper, for example.

The location of the openings 82 enables the reactance of the inductor assembly 30 to be adjustable. For example, initially the pin 82 is inserted into an opening 90. The reactance of the inductor assembly 30 is then measured. To increase the inductance of the inductor assembly, the pin 82 may be repositioned to a second opening 92. However, to decrease the reactance of the inductor assembly, the pin may be positioned into a third opening 94. In the exemplary embodiment, the pin 82 is positioned into a specific opening that creates an inductive reactance that is substantially equal to the capacitive reactance of the capacitor 16, thus forming a resonating tank circuit. Accordingly, the location of the pin 82 is adjustable such that the inductance can be chosen within certain limits when trying to resonate the inductor assembly 30 with a given capacitor, such as the capacitor 16. After, the pin 82 has been positioned in an opening 80 that creates the required reactance, the pin 82 is permanently affixed within the opening. For example, the opposite ends of the pin 82 are soldered or brazed to the first and second conductors 40 and 42, respectively.

In the exemplary embodiment, the locations of the openings 82 are determined in accordance with Table 1.

TABLE 1

| Openings (84) | Measured | Resonant |
|---|---|---|
| Positions | Inductance | Capacitor (for f₀) |
| φ₀ | L₀ | C₀(f₀) |
| φ₁ | L₁ | C₁(f₀) |
| φ₂ | L₂ | C₂(f₀) |
| φ_{N} | L_{N} | C_{N}(f₀) |

In the exemplary embodiment, the locations of the openings 82 are determined in accordance with Table 1. In this embodiment, π₀=π−the starting angle having a slope

$$s = \frac{w + {w}_{gap}}{2 π} ,$$

thus illustrating the location of a first opening 96 as shown in FIG. 2. Moreover, φ₂ illustrates the location of a second adjacent opening 98, etc. In the exemplary embodiment, the locations of the openings 84 are selected such that when the pin 82 is installed in a selected opening 84, a predetermined inductance is generated as shown in Table 1. In the exemplary embodiment, the locations of the openings 84 are calculated for specified pin positions in radians and corresponding capacitor values that resonate the inductors at the system frequency f₀. For example, the openings 82 may be located such that each opening 82 produces a change in inductance of 1 picoFarad (pF). Thus, positioning the pin 82 in the first opening 96 generates an initial inductance value. Whereas, positioning the pin 82 in the second opening generates an inductance value that is 1 pF less than the initial inductance value, etc. In this manner, the openings 80 provide incremental adjustments, e.g. 1 pF for example, in inductance. Thus, the pin may be inserted into the opening 82 that creates an inductive reactance that is substantially equal to the capacitive reactance of the capacitor 16, thus forming a resonant circuit.

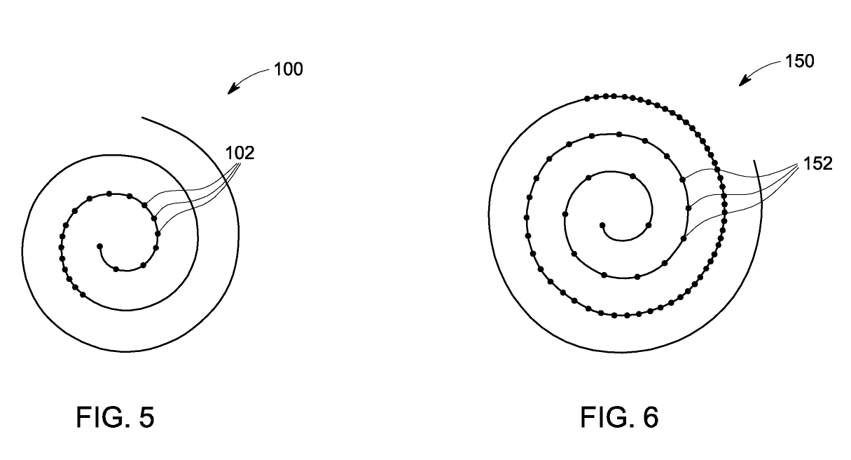

FIG. 5 is a top view of another exemplary rigid tunable spiral inductor assembly 100 that may be used with the tank circuit 10 shown in FIG. 1 in accordance with various embodiments. The inductor assembly 100 is substantially similar to the inductor assembly 30 shown in FIGS. 2-4. Specifically, the inductor assembly 100 includes the substrate 32, the first spiral conductor 40, and the second spiral conductor 42, all shown in FIG. 3. Moreover, the inductor assembly 100 includes a plurality of openings 102 that extend through the first spiral conductor 40, the substrate 32, and the second spiral inductor 42. In the example, the inductor assembly 100 is physically larger that the inductor assembly 30 and includes a plurality of openings 102 that are greater in number than the plurality of openings 82 formed in the inductor assembly 30. The openings 102 are located and formed substantially similar to the method described above with respect to inductor assembly 30. Specifically, the openings 102 are formed to generate a 1 pF difference in the inductance. Moreover, the additional openings 102, enable the inductor assembly 100 to generate an inductance that is greater than the inductance that is generated with the inductor assembly 30. For example, the inductor assembly 30 may be configured to generate an inductance between 25-65 pF.

FIG. 6 is a top view of another exemplary rigid tunable spiral inductor assembly 150 that may be used with the tank circuit 10 shown in FIG. 1 in accordance with various embodiments. The inductor assembly 150 is substantially similar to the inductor assemblies 30 and 100 shown in FIGS. 2-5. Specifically, the inductor assembly 150 includes the substrate 32, the first spiral conductor 40, and the second spiral conductor 42, all shown in FIG. 3. Moreover, the inductor assembly 150 includes a plurality of openings 152 that extend through the first spiral conductor, the substrate, and the second spiral inductor. In the example, the inductor assembly 100 is physically larger that the inductor assembly 30 and the inductor assembly 100. The inductor assembly 150 includes a plurality of openings 152 that are greater in number than the plurality of openings 82 formed in the inductor assembly 30 or the plurality of openings 102 formed in the inductor assembly 100. The openings 152 are located and formed substantially similar to the method described above with respect to inductor assemblies 30 and 100. Specifically, the openings 152 are formed to generate a 1 pF difference in the inductance. Moreover, the additional openings 152, enable the inductor assembly 150 to generate an inductance that is greater than the inductance that is generated with the inductor assembly 30 or the inductor assembly 100. For example, assuming that the inductor assembly 30 may be configured to generate an inductance between 25-65 pF, and the inductor assembly 100 is configured to generate an inductance between 25-65 pF, the inductor assembly 150 may be configured to generate an inductance between 25-90 pF.

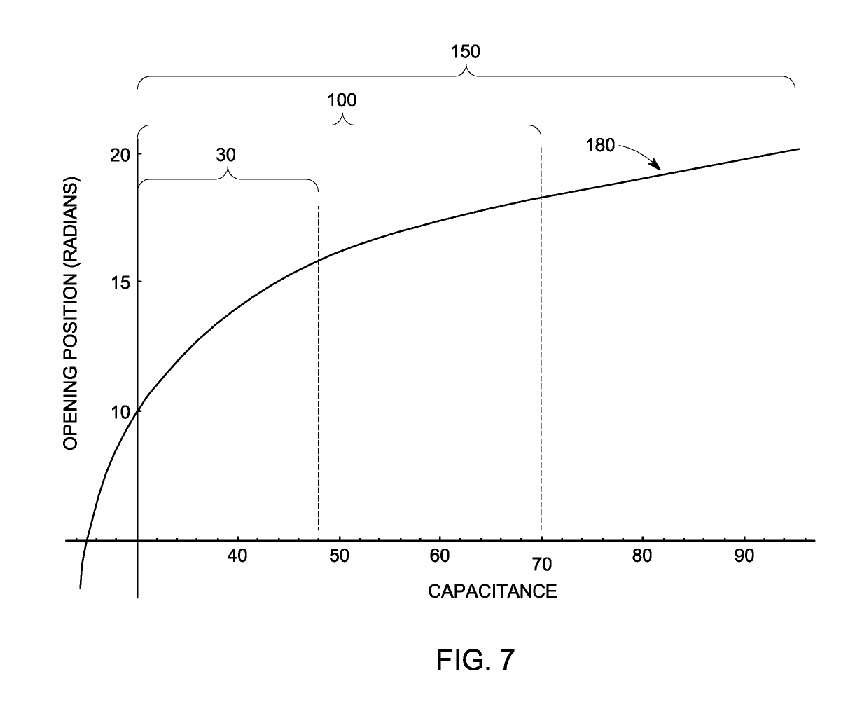

FIG. 7 is a graphical illustration of an exemplary function 180 that may be utilized to determine the locations of the openings in the inductor assemblies described herein. The X-axis represents the capacitance value of the exemplary capacitor 14 shown in FIG. 1. The Y-axis represents the position of the openings, e.g. openings 82, 152, and/or 154 described above in radians. In the exemplary embodiment, the information described above in Table 1 is utilized to generate the function 180. More specifically, by interpolating the information in Table 1, the function 180 (φ(C)) allows for the calculation of the openings 82, 152, and/or 154 for any given capacitor in either fixed increments or arbitrary increments. For example, as discussed above, the exemplary openings are formed at fixed increments of 1 pF. However, it should be realized that the openings may be formed at other arbitrary or non-fixed increments based on the desired or required application.

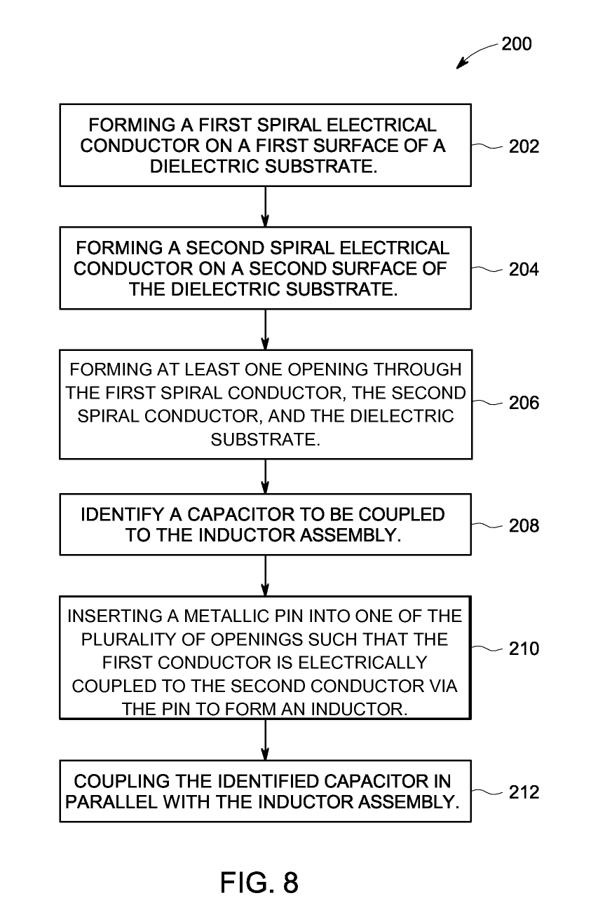

FIG. 8 is a flowchart of an exemplary method 200 of fabricating an inductor assembly such as the inductor assemblies shown in FIGS. 1-6. At 202 a first spiral electrical conductor is formed on a first surface of a dielectric substrate. In one embodiment, the first spiral conductor may be formed as a separate unit that is affixed to a dielectric substrate using, for example, an epoxy. In the exemplary embodiment, the first spiral conductor is formed on the dielectric substrate using a chemical vapor deposition procedure. More specifically, the first spiral conductor is produced by depositing a thin film of copper material on the dielectric substrate.

At 204, a second spiral conductor is formed on an opposite side of the dielectric substrate that includes the first spiral conductor. Similar to the first spiral conductor, the second spiral conductor may be formed as a separate unit that is affixed to the dielectric substrate or formed on the dielectric substrate using a chemical vapor deposition procedure. In the exemplary embodiment, the second spiral conductor is formed to be symmetrical to the first spiral conductor. More specifically, the first spiral conductor is the substantially the same size and has substantially the same shape and relative orientation of corresponding turns as the second spiral conductor.

At 206, at least one opening is formed through the first spiral conductor, the second spiral conductor, and the dielectric substrate. In the exemplary embodiment, a plurality of openings are formed through the first spiral conductor, the second spiral conductor, and the dielectric substrate.

At 208, the capacitor to be coupled to the inductor assembly is identified. More specifically, as discussed above, the inductor assemblies described herein are adjustable to enable the inductor assemblies to be utilized with various capacitors. Therefore, at 408 a capacitance value of the capacitor to be coupled to the inductor assembly to form the resonant circuit is identified.

At 210, a metallic pin is inserted into one of the plurality of openings such that the first conductor is electrically coupled to the second conductor via the pin to form an inductor. The opening designated to receive the pin is determined based on the value of the capacitance determined at step 208. As discussed above, the metallic pin is then secured to both the first and second conductors using, for example, a brazing or soldering procedure. Optionally, the metallic pin may be secured to both the first and second conductors using, for example, an epoxy material

At 212, a capacitor having the capacitance determined at step 208 is electrically coupled in parallel with the inductor assembly to form the resonant tank circuit portion of the RF coil. More specifically, the capacitor is soldered, brazed, or otherwise mechanically coupled to the ends of the inductor assembly formed on the substrate.

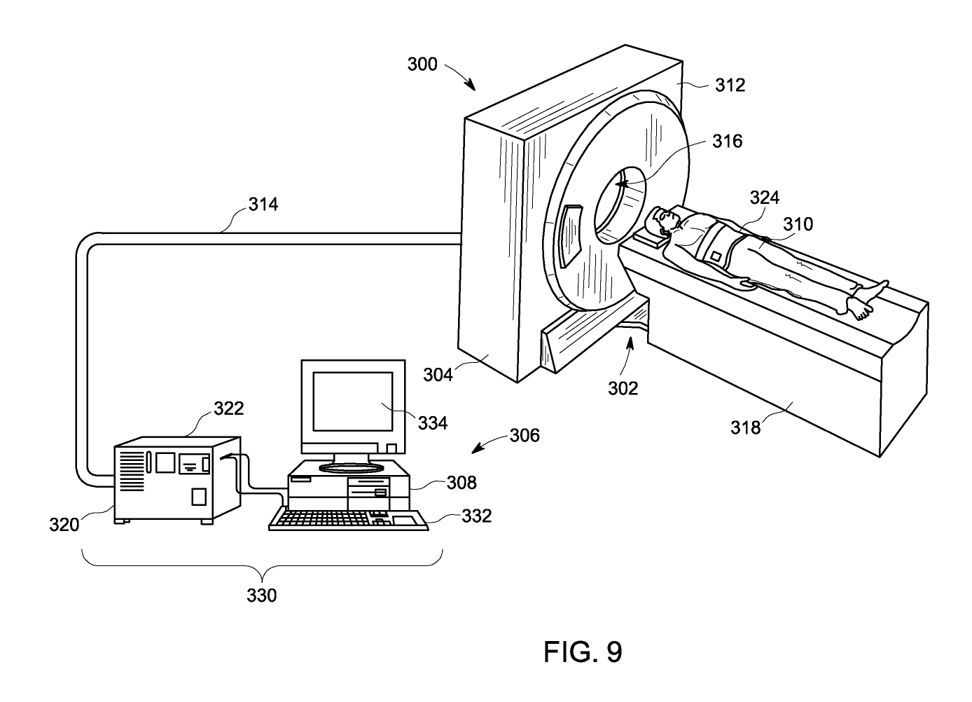

Various embodiments of the inductor assemblies described herein may be provided as part of, or used with, a medical imaging system, such as imaging system 300 shown in FIG. 9. It should be appreciated that although the imaging system 300 is illustrated as a single modality imaging system, the various embodiments may be implemented in or with multi-modality imaging systems. The imaging system 300 is illustrated as an MRI imaging system and may be combined with different types of medical imaging systems, such as a Computed Tomography (CT), Positron Emission Tomography (PET), a Single Photon Emission Computed Tomography (SPECT), as well as an ultrasound system, or any other system capable of generating images, particularly of a human. Moreover, the various embodiments are not limited to medical imaging systems for imaging human subjects, but may include veterinary or non-medical systems for imaging non-human objects, luggage, etc.

Referring to FIG. 9, the imaging system 300 includes an imaging portion 302 having an imaging unit 304 (e.g., imaging scanner) and a processing portion 306 that may include a processor 308 or other computing or controller device. In particular, the imaging unit 304 enables the imaging system 300 to scan an object or patient 310 to acquire image data, which may be image data of all or a portion of the object or patient 310. The imaging unit 304 includes a gantry 312 having one or more imaging components (e.g., magnets or magnet windings within the gantry 312) that allow acquisition of the image data. In multi-modality imaging systems, in addition to the magnet(s) for magnetic resonance imaging, an x-ray source and detector for computed-tomography imaging, or gamma cameras for nuclear medicine imaging may be provided. The imaging components produce signals that represent image data that is communicated to the processing portion 306 via a communication link 314 that may be wired or wireless. During an imaging scan by the imaging unit 304, the gantry 312 and the imaging components mounted thereon or therein may remain stationary or rotate about or along a center of rotation defining an examination axis through a bore 316. The patient 310 may be positioned within the gantry 312 using, for example, a motorized table 318.

In operation, an output of one or more of the imaging components is transmitted to the processing portion 306, and vice versa, which may include transmitting signals to or from the processor 308 through a control interface 320. The processor 308 also may generate control signals for controlling the position of the motorized table 318 or imaging components based on user inputs or a predetermined scan. During a scan, image data, such as magnetic resonance image data from the imaging components may be communicated to the processor 308 through a data interface 322 via the control interface 320, for example, as acquired by the surface coil 324, illustrated as a torso surface coil array in FIG. 9.

The processor 308 and associated hardware and software used to acquire and process data may be collectively referred to as a workstation 330. The workstation 330 includes a keyboard 332 and/or other input devices such as a mouse, a pointer, and the like, and a monitor 334. The monitor 334 displays image data and may accept input from a user if a touchscreen is available.

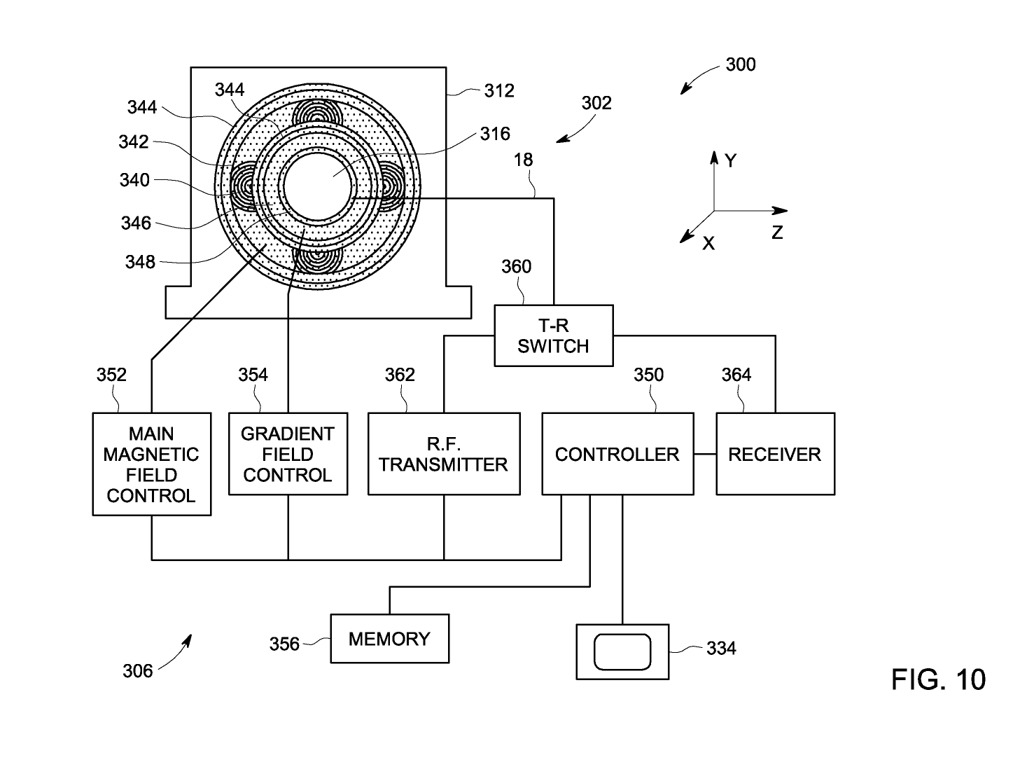

FIG. 10 is a schematic illustration of the imaging system 300 shown in FIG. 9. In the exemplary embodiment, the imaging system 300 also includes a superconducting magnet 340 formed from magnetic coils supported on a magnet coil support structure. However, in other embodiments, different types of magnets may be used, such as permanent magnets or electromagnets. A vessel 342 (also referred to as a cryostat) surrounds the superconducting magnet 340 and is filled with liquid helium to cool the coils of the superconducting magnet 340. A thermal insulation 344 is provided surrounding the outer surface of the vessel 342 and the inner surface of the superconducting magnet 340. A plurality of magnetic gradient coils 346 are provided within the superconducting magnet 340 and an RF transmit coil 348 is provided within the plurality of magnetic gradient coils 346. In some embodiments the RF transmit coil 348 may be replaced with a transmit and receive coil as described in more detail herein. The components within the gantry 312 generally form the imaging portion 302. It should be noted that although the superconducting magnet 340 is a cylindrical shaped, other shapes of magnets can be used.

The processing portion 306 also generally includes a controller 350, a main magnetic field control 352, a gradient field control 354, a memory 356, the display device 334, a transmit-receive (T-R) switch 360, an RF transmitter 362 and a receiver 364.

In operation, a body of an object, such as the patient 310 (shown in FIG. 14) or a phantom to be imaged, is placed in the bore 316 on a suitable support, for example, the motorized table 318 (shown in FIG. 14) or other patient table. The superconducting magnet 340 produces a uniform and static main magnetic field Bₒ across the bore 316. The strength of the electromagnetic field in the bore 316 and correspondingly in the patient 310, is controlled by the controller 350 via the main magnetic field control 352, which also controls a supply of energizing current to the superconducting magnet 340.

The magnetic gradient coils 346, which include one or more gradient coil elements, are provided so that a magnetic gradient can be imposed on the magnetic field Bₒ in the bore 316 within the superconducting magnet 340 in any one or more of three orthogonal directions x, y, and z. The magnetic gradient coils 346 are energized by the gradient field control 354 and are also controlled by the controller 350.

The RF transmit coil 348, which may include a plurality of coils (e.g., resonant surface coils), is arranged to transmit magnetic pulses and/or optionally simultaneously detect MR signals from the patient 310 if receive coil elements are also provided, such as the surface coil 324 (shown in FIG. 14) configured as an RF receive coil. The RF transmit coil 348 and the receive surface coil 324 are selectably interconnected to one of the RF transmitter 362 or receiver 364, respectively, by the T-R switch 360. The RF transmitter 362 and T-R switch 360 are controlled by the controller 350 such that RF field pulses or signals are generated by the RF transmitter 362 and selectively applied to the patient 310 for excitation of magnetic resonance in the patient 310. In the exemplary embodiment, any of the inductor assemblies described herein, may be utilized with the RF coils shown in FIG. 10.

Following application of the RF pulses, the T-R switch 360 is again actuated to decouple the RF transmit coil 348 from the RF transmitter 362. The detected MR signals are in turn communicated to the controller 350. The controller 350 includes a processor (e.g., image reconstruction processor), for example, the processor 308 (shown in FIG. 14), that controls the processing of the MR signals to produce signals representative of an image of the patient 310.

The processed signals representative of the image are also transmitted to the display device 334 to provide a visual display of the image. Specifically, the MR signals fill or form a k-space that is Fourier transformed to obtain a viewable image. The processed signals representative of the image are then transmitted to the display device 86.

In various embodiments, the RF transmitter 362 is configured to generate a single resonate frequency, for example, centered about the Larmor frequency. However, it should be noted that the RF transmitter 362 may be configured to generate other frequencies that are different than the Larmor frequency. Moreover, the MR signals and the image(s) generated may be encoded using any known technique in the art.

A technical effect of at least one of the inductor assemblies described herein is to provide a rigid inductor that is tunable to form a resonant circuit with a predetermined capacitor. The inductor assemblies described herein may be utilized with a plurality of RF coils. Specifically, the inductor assemblies described herein are rigid tunable spiral inductors that include double spiral conductors mounted on a dielectric board. The inductor assemblies allow for a good confinement of the magnetic field without using an external shield. Moreover, the rigid substrate allows the inductor assemblies to have a reliable geometry while also enabling the inductors to have variable inductance. The inductor assemblies may be modified by adding additional openings such that the placement of a pin is adjustable. Thus, the inductance of the inductor assemblies may be pre-selected within certain limits when trying to resonate the inductor assembly a given capacitor.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. An inductor assembly comprising:
a substrate having a first surface and an opposing second surface;
a first spiral electrical conductor formed on the first surface;
a second spiral electrical conductor formed on the second surface;
at least one opening extending through the first and second surfaces; and
a metallic pin configured to be inserted in the opening, the pin coupling the first conductor to the second conductor.

2. An inductor assembly in accordance with claim 1 further comprising a plurality of openings extending through the first and second surfaces, the metallic pin being inserted into only one of the plurality of openings.

3. An inductor assembly in accordance with claim 1 wherein the first and second conductors are configured to be electrically coupled to a capacitor, the inductor assembly further comprising a plurality of openings extending through the first and second surfaces, the metallic pin being inserted into only one of the plurality of openings based on a capacitance value of the capacitor.

4. An inductor assembly in accordance with claim 1 wherein the first and second conductors are configured to be electrically coupled to a capacitor, the inductor assembly further comprising a plurality of openings extending through the first and second surfaces, the metallic pin being inserted into only one of the plurality of openings such that a reactance of the inductor assembly is substantially equal to a reactance of the capacitor.

5. An inductor assembly in accordance with claim 1 wherein the inductor assembly is configured to be electrically coupled in parallel with a capacitor, the inductor assembly further comprising a plurality of openings, the pin configured to be inserted into one of the plurality of openings extending through the first and second surfaces, the metallic pin being inserted into only one of openings such that the inductor assembly is in resonance with the capacitor.

6. An inductor assembly in accordance with claim 1 wherein the first spiral conductor is symmetrical with the second spiral conductor.

7. An inductor assembly in accordance with claim 1 wherein the first and second spiral conductors include a plurality of turns that are coplanar.

8. An inductor assembly in accordance with claim 1 wherein the first and second spiral conductors have a substantially rectangular cross-sectional profile.

9. An inductor assembly in accordance with claim 1 wherein the substrate is fabricated from a dielectric material and the first and second conductors are fabricated from a copper material.

10. A Radio Frequency (RF) coil comprising:
a capacitor; and
an inductor assembly coupled in parallel with the capacitor, the inductor assembly including
a substrate having a first surface and an opposing second surface;
a first spiral electrical conductor formed on the first surface;
a second spiral electrical conductor formed on the second surface;
at least one opening extending through the first and second surfaces; and
a metallic pin configured to be inserted in the opening, the pin coupling the first conductor to the second conductor.

11. An RF coil in accordance with claim 10 wherein the inductor assembly further comprises a plurality of openings extending through the first and second surfaces, the metallic pin being inserted into only one of the plurality of openings.

12. An RF coil in accordance with claim 10 wherein the inductor assembly further comprises a plurality of openings extending through the first and second surfaces, the metallic pin being inserted into only one of the plurality of openings based on a capacitance value of the capacitor.

13. An RF coil in accordance with claim 10 wherein the inductor assembly further comprises a plurality of openings extending through the first and second surfaces, the metallic pin being inserted into only one of the plurality of openings such that a reactance of the inductor assembly is substantially equal to a reactance of the capacitor.

14. An RF coil in accordance with claim 10 wherein the first and second spiral conductors include a plurality of turns that are coplanar.

15. An RF coil in accordance with claim 10 wherein the first and second spiral conductors have a substantially rectangular cross-sectional profile.

16. An RF coil in accordance with claim 10 wherein the substrate is fabricated from a dielectric material and the first and second conductors are fabricated from a copper material.

17. A method of fabricating an Radio Frequency (RF) coil, said method comprising:
forming a first spiral electrical conductor on a first surface of a dielectric substrate;
forming a second spiral electrical conductor on a opposite second surface of the dielectric substrate;
forming at least one opening through the dielectric substrate and the first and second conductors;
inserting a metallic pin into the at least one opening such that the first conductor is electrically coupled to the second conductor via the pin to form an inductor; and
coupling the inductor assembly in parallel with a capacitor.

18. A method in accordance with claim 17 further comprising:
forming a plurality of openings through the dielectric substrate and the first and second conductors;
inserting the metallic pin into one of the openings based on a capacitance value of the capacitor.

19. A method in accordance with claim 17 further comprising:
forming a plurality of openings through the dielectric substrate and the first and second conductors;
selecting an opening such that a reactance of the inductor assembly is substantially equal to a reactance of the capacitor; and
securing the metallic pin within the opening.

20. A method in accordance with claim 17 further comprising forming the first spiral electrical conductor and the second spiral conductor to include a plurality of coplanar turns.
